(19) United States
(12) Patent Application Publication
(10) Pub. No.: US 2010/0259376 A1
(43) Pub. Date: Oct. 14, 2010

(54) COMPLEX TESTER FOR HEAT AND SMOKE FIRE-SENSING APPARATUS

(75) Inventor: Seong-Kook HONG, Gyeonggi-do (KR)

Correspondence Address: CHA & REITER, LLC, 210 ROUTE 4 EAST STE 103, PARAMUS, NJ, 07652, US

(73) Assignee: WONWOO EF ENG CO., LTD., Seoul (KR)

(21) Appl. No.: 12/825,847

(22) Filed: Jun. 29, 2010

Related U.S. Application Data
(63) Continuation of application No. PCT/KR2009/001948, filed on Apr. 15, 2009.

(30) Foreign Application Priority Data
Apr. 29, 2008 (KR) 10-2008-0040019

(51) Int. Cl. G08B 29/00

(52) U.S. Cl. 340/515

(57) ABSTRACT

Disclosed is a complex tester for a heat and smoke fire sensing apparatus. The complex tester includes: an oil tank filled with smoke oil, an oil heater mounted on a oil heater fastening unit and connected to a power source, a wick connected to the oil within the oil tank and the oil heater so as to supply the oil to the oil heater, a blower fan provided between the oil tank and a heater mounting unit so as to blow smoke to the outside wherein the smoke is generated as the oil is burnt by the oil heater, a heater mounted on a heater fastening plate formed from a mica plate and connected to the power source, and a bellows cover mounted on the top of the case, the bellows cover being adapted to come into close contact with the circumference of the fire sensing apparatus even if a fire sensing apparatus mounting surface is not flat or the fire sensing apparatus mounting surface and the heater mounting unit do not form a right angle, whereby the bellows cover prevents the leakage of smoke or heat to the outside. The complex tester prevents a user's health from being injured even if the user repeatedly inhales smoke when testing the smoke generator, and radiates a large quantity of far infrared rays when the heater is heated. In addition, it is easy and convenient to make the entire circumference of the bellows cover and the fire sensing apparatus mounting surface come into close contact with each other, thereby preventing the leakage of heat or smoke to the outside.

### CROSS REFERENCE TO RELATED APPLICATIONS

The present application is a Continuation of PCT/KR 2009/001948 filed on Apr. 15, 2009 which in turn claims a priority to a Korean Patent application no. 10-2008-0040019 fled on Apr. 29, 2008.

### TECHNICAL FIELD

The present invention relates to a complex tester for a heat and smoke fire sensing apparatus, and more particularly to a complex tester for a heat and smoke fire sensing apparatus, which does not cause a user's health to be injured even if smoke is repeatedly inhaled when testing a smoke generator, which causes a large quantity of far infrared rays to be radiated when a heater is heated, which allows a user to easily and conveniently make the tester and a fire sensing apparatus mounting surface come into close contact with each other, and which prevents the leakage of heat or smoke to the outside thereof.

### BACKGROUND

In general, a building is provided with a fire alarm system for activating an alarm so as to allow a number of persons to be alerted to the existence of a fire when the fire occurs in the building.

Such a fire alarm system includes a fire sensing apparatus for sensing smoke or heat and outputting a predetermined signal when a fire occurs, and an alarming apparatus for receiving the predetermined signal and producing an alarm sound.

Here, the fire sensing apparatus includes a heat sensor using heat produced by the fire, and a smoke sensor capturing smoke. A light emitting diode (LED) mounted on an outer circumference of a conventional sensor is turned on when the temperature of heat or the concentration of smoke arrives at a predetermined level, which means that the activation of the sensor is initiated.

A bimetal-type, thermo-semiconductor-type or thermocouple-type sensor may be employed as a heat sensor in such a fire sensing apparatus. A photoelectric-type or ionization-type sensor may be employed as the smoke sensor, and a photosensitive sensor or a diffusion-type sensor is used herein.

A tester for a fire sensing apparatus is a means for checking an operating condition of a fire sensing apparatus (heat sensor or fire sensor), and is classified into a heat generator for checking the operating condition of the fire sensing apparatus (heat sensor) by generating a certain level of heat, or a smoke generator for checking a fire sensing apparatus (smoke sensor) by generating smoke in a predetermined certain concentration.

However, such testers for a fire sensing apparatus, i.e. a smoke generator and a heat generator are separately provided. As a result, since a smoke sensor should be tested with a smoke generator, and a heat sensor should be tested with a heat generator, it is necessary to keep each of the smoke generator and the heat generator ready. In addition, since a smoke sensor and a heat sensor should be separately tested with the kept devices, respectively, there is an inconvenience in their use.

Among the testers for a fire sensing apparatus, the smoke generator has a problem in that paraffin wax is used as a fuel for generating smoke. The paraffin is heated by a heater to produce smoke. However, harmful substances are generated when the paraffin is burnt, and if such harmful substances are continuously inhaled due to repeated tests, a user's health may be greatly injured.

Another problem of such a conventional fire sensing apparatus tester is caused by a cover surrounding the heat sensor or the smoke sensor. In order to test the heat sensor, it is necessary to make the cover of the heat generator come into close contact with a fire sensing apparatus mounting surface around the heat sensor, and then to generate heat. In order to test the smoke sensor, it is necessary to make the cover of the smoke generator come into close contact with the fire sensing apparatus mounting surface around the smoke sensor, and then to generate smoke. The covers for the heat generator and the smoke generator are formed from a hard metal or a hard synthetic resin. Such a hard cover is poorly conformable to a fire sensing apparatus mounting surface, and if the fire sensing apparatus mounting surface is uneven, the cover does not properly come into close contact with the fire sensing apparatus mounting surface over the circumference of the cover. As a result, there is a problem in that all heat or smoke generated within the cover leaks to the outside.

In addition, a conventional fire sensing apparatus tester with such a hard cover has a problem in that it is necessary to adjust the angle of the cover whenever the circumference of the cover comes into contact with a fire sensing apparatus mounting surface around the heat sensor or the smoke sensor. For this purpose, a plane formed by the circumference of the end of the cover and the heat sensing apparatus mounting surface should be parallel to each other. Therefore, whenever the tester is used, it is necessary to turn the hard cover about an end of a link, which is very complicated. If a test is performed in a state in which the cover is not properly turned, heat or smoke leaks through undone areas between the circumference of the end of the cover and the heat sensing apparatus mounting surface, which degrades the reliability for test results.

Therefore, what is needed is a fire sensing apparatus tester which can solve the above-mentioned problems.

### SUMMARY OF THE INVENTION

The present invention is made in order to solve the above-mentioned problems, and the present invention provides a complex tester for a heat and smoke fire sensing apparatus, which is adapted to perform a test for a smoke sensor as well as a test for a heat sensor in parallel.

In addition, the present invention provides a complex tester for a heat and smoke fire sensing apparatus, which does not cause a user's health to be injured even if the user repeatedly inhales smoke when testing a smoke generator.

In addition, the present invention provides a complex tester for a heat and smoke fire sensing apparatus, which causes a large quantity of far infrared rays to be radiated when a heater is heated.

Furthermore, the present invention provides a complex tester for a heat and smoke fire sensing apparatus which allows a user to easily and conveniently make the complex tester and the fire sensing apparatus mounting surface come into close contact with each other, and prevents heat or smoke from leaking out to the surrounding atmosphere.

In accordance with an aspect of the present invention, there is provided a complex tester for a fire sensing apparatus, including: (a) a complex test unit including: a smoke generator comprising an oil tank received within a case, an anti-vibration spring provided between an inner side of the case and the oil tank so as to resiliently support the oil tank toward an opened part of the case, an oil heater provided within the oil tank, and a blower fan mounted on the top of the oil tank so as to blow smoke to the outside, wherein the smoke is generated as the oil is burnt by the oil heater; a heat generator comprising a heater mounted through a heater mounting unit on the top of the oil tank, and a temperature sensor provided in the heater mounting unit so as to sense the internal temperature of the heater mounting unit; and an air-tightness retaining means mounted on the top of the case, and coming into close contact with the circumference of the fire sensing apparatus, thereby preventing the leakage of smoke and heat to the surrounding atmosphere; (b) a support unit comprising a lower support, and an upper support fitted in the lower support so that the upper support is inserted into or extracted from the lower support, depending on the lower support, and a link connected to an end of the upper support and the case so as to rotatably support the test unit on the upper support; and (c) a controller connected to the oil heater, the blower fan, the heater and the temperature sensor so as to control them.

In accordance with an exemplified embodiment of the present invention, the oil is smoke oil. In addition, the oil may be formed from an edible oil component harmless to humans.

In accordance with another exemplified embodiment of the present invention, the complex tester may further include a heater fastening plate provided within the heater mounting unit, wherein the heater fastening plate is formed from a mica plate which is excellent in heat resistance and insulation property, and radiates far infrared rays.

The air-tightness retaining means may include: a bellows cover fastening ring, the circumference of one end of which is fitted on the circumference of an end of the case, and a bellows cover, one end of which is fitted on the circumference of the other end of the bellows cover fastening ring 26, the bellows being adapted to be retracted and restored to its original state.

Effects obtained by the present invention operated as described above are briefly set forth below.

The inventive complex tester has a means for generating heat and a means for generating smoke, which are provided within a test unit 10 and controlled by a single controller 40. As a result, it is possible to test a heat sensor and a smoke sensor with one tester. Therefore, since a test for a smoke sensor as well as a test for a heat sensor can be performed in parallel with the inventive complex tester, economic loss can be reduced to that extent, and convenience can be enhanced.

In addition, the inventive complex tester uses smoke oil or oil formed from an edible oil component harmless to humans as a fuel for generating smoke. Therefore, since the smoke is not harmful to humans even if it is repeatedly inhaled due to carelessness when testing a smoke generator, a user's health will not be substantially injured.

Furthermore, the heater fastening plate for testing a heat sensor is formed from a mica plate. Since the mica plate is excellent in heat resistance and has a good insulation property, it is suitable for fastening a conductive heater of high temperature. In addition, since the mica plate radiates a large quantity of far infrared rays, it is effective in improving the user's health.

Another advantage of the present invention is resulted from a bellows cover. When the inventive bellows cover is caused to come into close contact with a fire sensing apparatus mounting surface, the bellows cover is properly retracted so that the entire circumference of the end of the bellows cover comes into contact with the mounting surface, even if the plane of the circumference of the end of the bellows cover and the fire sensing apparatus mounting surface are not parallel to each other. Therefore, if the bellows cover is opposed to the mounting surface and caused to come into close contact with the mounting surface, the bellows cover is retracted to conform to the mounting surface, so that the bellows cover and the mounting surface come into close contact with each other. Accordingly, it is very easy and convenient to make the bellows cover and the fire sensing apparatus mounting surface come into close contact with each other, thereby preventing the leakage of heat or smoke within the bellows cover to the outside.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a front view of the inventive complex tester for a heat and smoke fire sensing apparatus showing the outer appearance of the tester;

FIG. 2 is a schematic exploded perspective view showing internal components of a test unit; and

FIG. 3 is a cross-sectional view showing the components of FIG. 2 in the assembled state.

### DETAILED DESCRIPTION OF THE INVENTION

Hereinafter, exemplary embodiments of the present invention will be described with reference to the accompanying drawings. In the following description, a detailed description of known functions and configurations incorporated herein will be omitted when it may make the subject matter of the present invention rather unclear. Further, various specific definitions found in the following description are provided only to help general understanding of the present invention, and it is apparent to those skilled in the art that the present invention can be implemented without such definitions.

Hereinafter, a complex tester for a fire sensing apparatus in accordance with the present invention will be described in detail with reference to the accompanying drawings.

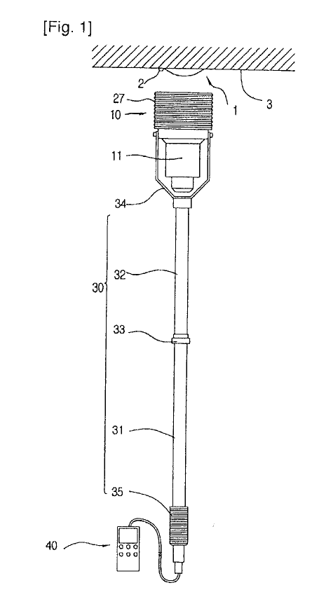

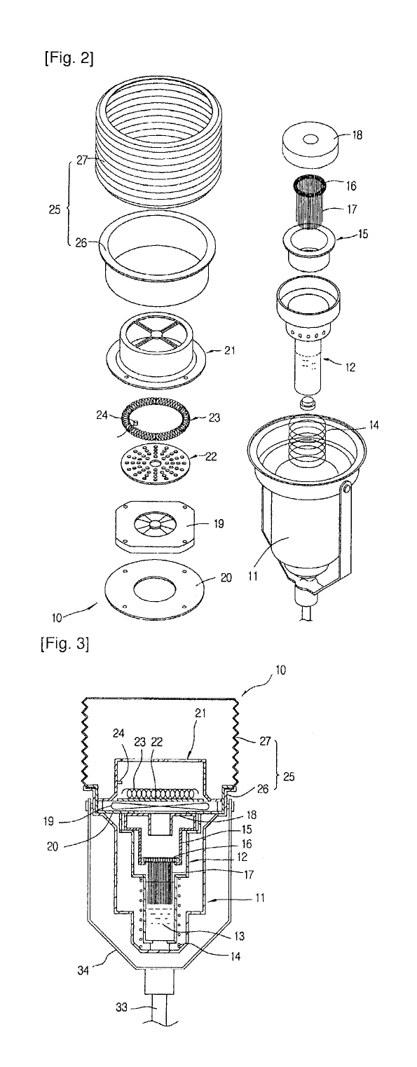

FIG. 1 is a front view of the inventive complex tester for a heat and smoke fire sensing apparatus showing the outer appearance of the tester, FIG. 2 is a schematic exploded perspective view showing internal components of a test unit, and FIG. 3 is a cross-sectional view showing the components of FIG. 2 in the assembled state.

In general, the inventive complex tester for a fire sensing apparatus includes a test unit 10, a support unit 30 and a controller.

The test unit 10 is provided with a case 11, in which a plurality of structural components is received. An oil tank 12 filled with oil 11 is received within the case. Here, smoke oil harmless to humans is used as the oil. Alternatively, oil formed from an edible oil component may be used. Therefore, since the present invention uses smoke oil or oil formed from an edible oil component harmless to humans as a fuel for generating smoke, the smoke is not so harmless to humans even if smoke is repeatedly inhaled due to carelessness when testing a smoke generator.

An anti-vibration spring 14 is interposed between the inner side of the case 11 and the oil tank 12 so as to resiliently support the oil tank 12 toward the opened side of the case 11. In addition, an oil heater fastener 15 is provided within the oil tank 12. The oil heater fastener 15 is provided with an oil heater 16 connected to a power source, and a wick is connected between the oil 13 in the oil tank 12 and the oil heater 16 so as to supply the oil 13 to the oil heater 16.

An oil leak-proof ring 18 is coupled to the oil heater fastener 15 so as to prevent the leakage of the oil 13 from the oil tank 12, and a heater mounting unit 21 is mounted on the top of the oil tank 12. Between the oil tank 12 and the heater mounting unit 21, a blower fan 19 is provided so as to blow smoke out to the exterior, wherein the smoke is generated as the oil 13 is burnt by the oil heater 16. A blower fan fastening plate 20 is fixed to the blower fan 19 and the heater mounting unit 21 so as to support the blower pan 19. The above-mentioned structural components generate smoke to be used by the inventive complex tester for testing a fire sensing apparatus. Therefore, a combination of the above-mentioned components will be referred to as smoke generator in the detailed description of the invention.

The heater mounting unit 21 is installed within the oil tank 12, and the heater fastening plate 22 is installed within the heater mounting unit 21. In addition, the heater fastening plate 22 is equipped with the heater 23 which is connected to a power source, and a temperature sensor 24 is mounted on a side of the interior of the heater mounting unit 21 so as to sense the internal temperature of the heater mounting unit 21.

Here, the heater fastening plate 22 is formed from a mica plate which is excellent in heat resistance and insulation property, and radiates a large quantity of far infrared rays when it is heated. Due to the excellent heat resistance and insulation property, the mica plate is suitable for fastening the conductive heater of high temperature. The mica plate is effective in improving the operator's health since it radiates far infrared rays when it is heated.

The above-mentioned components generate heat for testing a fire sensing apparatus, which is another function of the inventive complex tester. Therefore, a combination of the above-mentioned components is also referred to as a heat generator in the detailed description of the invention.

On the top of the heater mounting unit 21, an air-tightness retaining means 25 is installed which comes into close contact with the circumference of the fire sensing apparatus 1 so as to prevent the leakage of smoke or heat to the exterior, even if a fire sensing apparatus mounting surface 3 is not flat or the fire sensing apparatus mounting surface and the heater mounting unit 21 do not form a right angle with each other.

Here, the air-tightness retaining means 25 may consist of a bellows cover fastening ring 26, one end of which is engaged around the end of the case 11, and a bellows cover 27, one end of which is engaged around the other end of the bellows cover fastening ring 26, the bellows cover 27 being adapted to be retracted and restored to the original state.

If the bellows cover 27 is caused to come into close contact with the fire sensing apparatus mounting surface 3, the bellows cover 27 is properly retracted so that the entire circumference of the end of the bellows cover 27 evenly comes into contact with the mounting surface 3, even if the plane of the circumference of the end of the bellows cover 27 and the mounting surface 3 are not parallel to each other.

Therefore, if the bellows cover 27 is opposed to the mounting surface 3 and caused to come into close contact with the mounting surface 3, the bellows cover 27 is retracted to be suitable for the mounting surface 3, so that the bellows cover 27 and the mounting surface 3 come into close contact with each other. Accordingly, it is very easy and convenient to make the bellows cover 27 and the mounting surface come into close contact with each other, and the leakage of heat or smoke within the bellows cover 27 can be prevented.

The support unit 30 includes a lower support 31, within which electric wires are received, and an upper support 32, one end of which is fitted in the lower support 31, and which is inserted into or extracted from the lower support 31, depending on the lower support 31.

An adjustment unit 33 is installed on the lower support 31 and the upper support 32 so as to fasten them to each other or release them from one another. If the adjust unit 33 is rotated in one direction, the lower support 31 and the upper support 32 are released from one another, so that the upper support 32 can be inserted or extracted from the lower support 31. If the adjustment unit 33 is rotated in the other direction, the lower support 31 and the upper support 32 are fixed to each other, so that the adjusted condition is retained as it is. A handle 35 is provided on the end of the lower support 31. A link 34 is connected to the end of the upper support 32 and the case 11 of the test unit so as to support the test unit 10 on the upper support 32.

The controller 40 is connected to a power source, and is also connected to the oil heater 16, the blower fan 19, the heater 23, and the temperature sensor 24 so as to control them.

Now, the operation of the inventive complex tester for a heat and smoke fire sensing apparatus will be described.

At first, if the fire sensing apparatus 1 is a heat sensor, the controller 40 is manipulated to activate the heater 23. If the heater 23 is heated to a proper temperature, the blower fan 19 is driven. Therefore, heated air of high temperature is blown to the fire sensing apparatus through the heater mounting unit 21, the bellows cover fastening ring 26, and the bellows cover 27.

If the air is blown for a predetermined length of time in the state in which the heater 23 is heated, an LED of the fire sensing apparatus 1 is turned on. At this time, an inspector checks the temperature of the heater 23, the length of blowing time and the length of operating time of the LED 2 of the fire sensing apparatus 1, and compares them with standard values so as to determine whether there is a problem or not in the fire sensing apparatus 1.

If the fire sensing apparatus 1 is a smoke sensor, the controller 40 is manipulated so as to operate the oil heater 16. If the oil, which is suctioned to the wick 17 as the oil heater 16 is heated, is initiated to be burnt, the blower fan 19 is operated. Therefore, smoke, which is generated as the oil 13 is burnt, is blown to the fire sensing apparatus 1.

If the smoke is blown for a predetermined length of time, the LED 2 of the fire sensing apparatus 1 is turned on. At this time, an inspector checks the temperature of the oil heater 16, the length of blowing time and the length of operating time of the LED 2 of the fire sensing apparatus 1, and compares them with standard values so as to determine whether there is a problem or not in the fire sensing apparatus 1.

The inventive complex tester for a heat and smoke fire sensing apparatus has various advantages as follows.

First, the inventive complex tester has a means for generating heat and a means for generating smoke, which are provided within a test unit 10 and controlled by a single controller 40. As a result, it is possible to test a heat sensor and a smoke sensor with one tester. Therefore, since a test for a smoke sensor as well as a test for a heat sensor can be performed in parallel with the inventive complex tester, economic loss can be reduced and the tester can be conveniently used.

Second, the inventive complex tester uses smoke oil or oil formed from an edible oil component harmless to humans as a fuel for generating smoke. Therefore, since the smoke is not harmful to humans even if it is repeatedly inhaled due to carelessness when testing the smoke generator, a user's health will not be substantially injured.

Third, the heater fastening plate for testing a heat sensor is formed from a mica plate. Since the mica plate is excellent in heat resistance and has a good insulation property, it is suitable for fastening a conductive heater of high temperature. In addition, since the mica plate radiates a large quantity of far infrared rays, it is effective in improving the user's health.

Fourth, when the inventive bellows cover 27 is caused to come into close contact with a fire sensing apparatus mounting surface 3, the bellows cover 27 is properly retracted so that the entire circumference of the end of the bellows cover 27 evenly comes into contact with the mounting surface 3, even if the plane of the circumference of the end of the bellows cover 27 and the mounting surface 3 are not parallel to each other. Therefore, if the bellows cover 27 is opposed to the mounting surface 3 and caused to come into close contact with the mounting surface 3, the bellows cover 27 is retracted to conform to the mounting surface 3, so that the bellows cover 27 and the mounting surface 3 come into close contact with each other. Accordingly, it is very easy and convenient to make the bellows cover 27 and the mounting surface come into close contact with each other, thereby preventing the leakage of heat or smoke within the bellows cover 27 to the outside.

### INDUSTRIAL APPLICABILITY

Although several exemplary embodiments of the present invention have been described for illustrative purposes, those skilled in the art will appreciate that various modifications, additions and substitutions are possible, without departing from the scope and spirit of the invention as disclosed in the accompanying claims.

1. A complex tester for a fire sensing apparatus, comprising:
(a) a complex test unit comprising:
a smoke generator comprising an oil tank received within a case, an anti-vibration spring provided between an inner side of the case and the oil tank so as to resiliently support the oil tank toward an opened part of the case, an oil heater provided within the oil tank, and a blower fan mounted on the top of the oil tank so as to blow smoke to the outside, wherein the smoke is generated as the oil is burnt by the oil heater;
a heat generator comprising a heater mounted through a heater mounting unit on the top of the oil tank, and a temperature sensor provided in the heater mounting unit so as to sense the internal temperature of the heater mounting unit; and
an air-tightness retaining means mounted on the top of the case, and coming into close contact with the circumference of the fire sensing apparatus, thereby preventing the leakage of smoke and heat to the surrounding atmosphere;
(b) a support unit comprising a lower support, and an upper support fitted in the lower support so that the upper support is inserted into or extracted from the lower support, depending on the lower support, and a link connected to an end of the upper support and the case so as to rotatably support the test unit on the upper support; and
(c) a controller connected to the oil heater, the blower fan, the heater and the temperature sensor so as to control them.

2. The complex tester as claimed in claim 1, wherein the oil is smoke oil.

3. The complex tester as claimed in claim 1, wherein the oil is formed from an edible oil component harmless to humans.

4. The complex tester as claimed in claim 1, further comprising a heater fastening plate provided within the heater mounting unit, wherein the heater fastening plate is formed from a mica plate which is excellent in heat resistance and insulation property, and radiates far infrared rays.

5. The complex tester as claimed in claim 1, wherein the air-tightness retaining means comprises: a bellows cover fastening ring, the circumference of one end of which is fitted on the circumference of an end of the case, and a bellows cover, one end of which is fitted on the circumference of the other end of the bellows cover fastening ring 26, the bellows being adapted to be retracted and restored to its original state.
